(19) United States
(12) Patent Application Publication
(10) Pub. No.: US 2012/0007405 A1
(43) Pub. Date: Jan. 12, 2012

(54) CAR SEAT HEADREST

(76) Inventor: JANE EUNJOO KIM, Northridge, CA (US)

(21) Appl. No.: 12/831,031

(22) Filed: Jul. 6, 2010

(51) Int. Cl. B60N 2/48

(52) U.S. Cl. 297/397

(57) ABSTRACT

A car seat headrest comprises a holding bar and a head support portion attached to the holding bar. The holding bar may be attachable to a car seat. The head support portion may extend above a seat base of the car seat when the holding bar is attached to the car seat.

### BACKGROUND OF THE INVENTION

The present invention generally relates to a car seat headrest, and more specifically, to a device for supporting the head and neck of car passengers while taking a nap.

Presently, car headrests are generally positioned to support the back of the head and neck of passengers sitting in a car. However, car headrests may not provide support for napping passengers whose heads may have dropped to one side.

As can be seen, there is a need for a way to support the head and neck of napping car passengers.

### SUMMARY OF THE INVENTION

In one aspect of the present invention, an apparatus comprises a holding bar attachable to a car seat; and a head support portion attached to the holding bar, the head support portion extending above a seat base of the car seat when the holding bar is attached to the car seat.

In another aspect of the present invention, an apparatus may comprise a holding bar having a U shape and also having one or more openings operable to accept one or more headrest stays of a car seat; an extension portion having a Z shape, the extension portion having a first end attached to a first end of the holding bar; an insert bar attached to a second end of the extension portion, the insert bar extending above a seat base of the car seat when the holding bar is attached to the car seat; and a pillow having a cylindrical shape that is wrapped around at least a portion of the head support portion.

These and other features, aspects and advantages of the present invention will become better understood with reference to the following drawings, description and claims.

### BRIEF DESCRIPTION OF THE DRAWINGS

FIG. 1: is a perspective view of a car seat headrest in accordance with a first embodiment of the present invention mounted on a car seat;

FIG. 2: is a perspective view of the car seat headrest of FIG. 1;

FIG. 3: is an exploded view of the car seat headrest of FIG. 1;

FIG. 4: is top plan view of the car seat headrest of FIG. 1;

FIG. 5: is an exploded perspective view of a car seat headrest in accordance with a second embodiment of the invention;

FIG. 6: is a side elevation view of the car seat headrest of FIG. 5;

FIG. 7: is a top plan view of a car seat headrest in accordance with a third embodiment of the invention; and

FIG. 8: is a detail cross-section view taken on line 8-8 of FIG. 7.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide a car seat headrest that may be attached to standard car seats to provide support for passenger heads and necks when passengers lean to one side, such as often occurs when passengers fall asleep in a car.

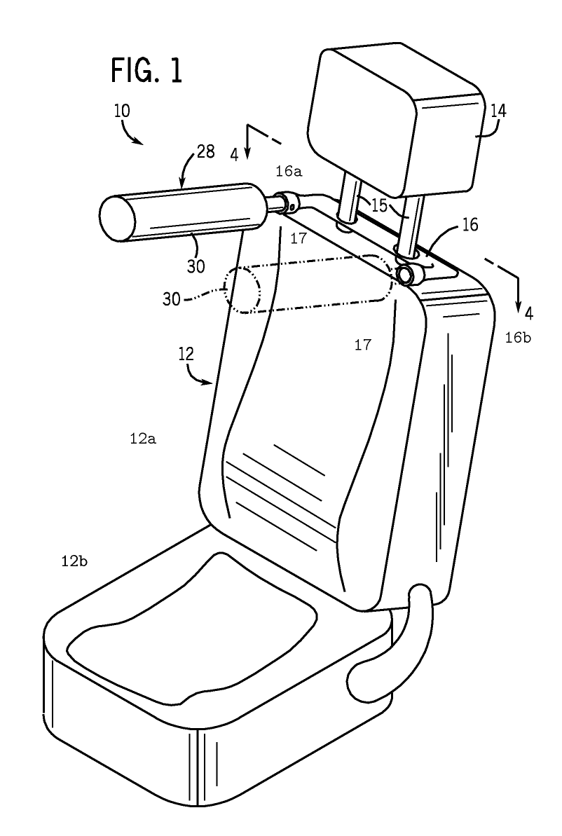

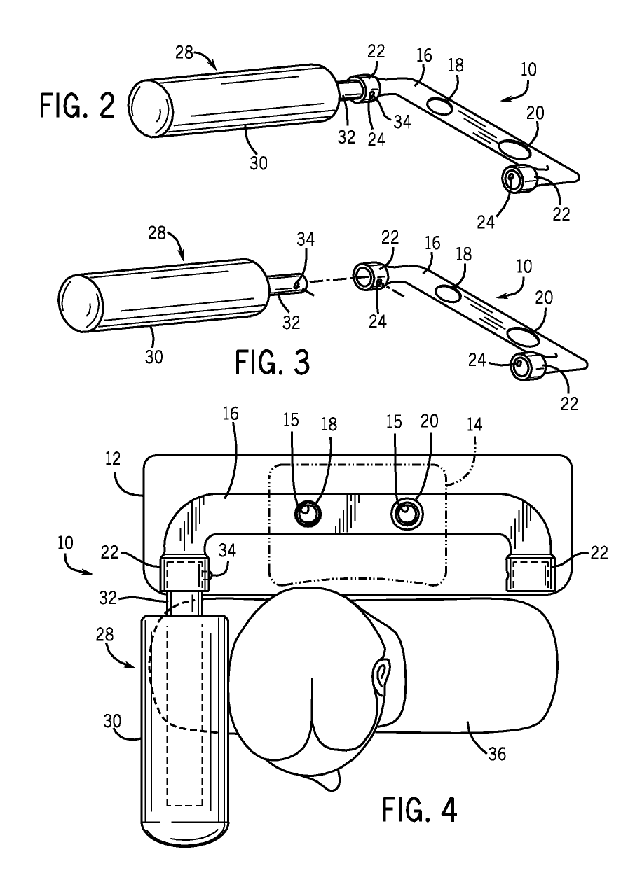

With reference to FIGS. 1, 2, 3, and 4, a car seat headrest 10 may comprise a holding bar 16 and a pillow unit 28.

The holding bar 16 may be a U-shaped bar or hollow tube made of a hard supportive material such as metal or plastic, and may be shaped as a flat rectangle, an oval, or a cylinder. The holding bar 16 may have a length of about 13 to 15 inches and may have a diameter of about ¾ to 1 inch. The holding bar 16 may have a pair of legs 16a and 16b about 2 inches long that may each have a locking collar 22 wrapped around the ends of the legs 16a and 16b. The locking collars 22 may each have a through-hole 24 to lock an insert bar 32 inserted into the locking collar 22 to attach the insert bar 32 to the holding bar 16 via a pop-up button 34 on the insert bar 32 being locked into the through-hole 24.

The holding bar 16 may also comprise headrest mount holes at about its center. The headrest mount holes may be a pair of holes including a fitted hole 18 and an adjusting hole 20. The fitted hole 18 may be an oval about ¾ inches wide and about 2 and ¼ inches away from its closest leg 16a of the holding bar 16. The adjusting hole 20 may be an oval about 1 and ¼ inches wide and about 1 inch from its closest leg 16b of the holding bar 16.

The headrest mount holes 18 and 20 may be used to secure the holding bar 16 to a car seat. A headrest 14 on a car seat may be disconnected from a backrest 12a of a car seat. The holes 18 and 20 may be positioned about headrest stay holes 17 on the backrest 12a of a car seat 12. A headrest 14 may then be installed onto the backrest 12a by inserting one or more of its one or more headrest stays 15 through one or more of the holes 18 and 20 and into one or more of the headrest stay holes 17. Thus, the holding bar 16 may be secured between the headrest 14 and the backrest 12a of a car seat via the headrest stays 15 of the headrest 14.

The pillow unit 28 may comprise an insert bar 32 and a pillow 30. The insert bar 32 may be a cylindrical tube or bar approximately 5 to 6 inches long and approximately ½-inch in diameter. The insert bar 32 may have a pop-up button 34 near one side of the insert bar 32 that may connect with the through holes 24 on the locking collars 22 on the holding bar 16 to secure the insert bar 32 to the holding bar 16.

The pillow 30 may be cylindrical in shape, about 6 inches long, about 3 to 4 inches in diameter, and may have about a ½-inch wide entering space in the center to accept at least a portion of the insert bar 32. The pillow 30 may be a firm, padded object that may provide support and comfort for a user's neck and head. The pillow 30 may be made of any suitable soft material, including but not limited to rubber, plastic, gel, cloth, or any soft textile or synthetic material.

In use, the holding bar 16 may be secured to a car seat. The insert bar 32 may be inserted into a locking collar 22 of the holding bar 16 and be secured via a pop-up button 34 and through-holes 24. When the insert bar 32 is secured to the holding bar 16, the insert bar 32 and the pillow 30 may extend horizontally above the seat base 12b of the car seat 12 from the top of the backrest 12a. A user sitting on the seat base 12b may lean his head or neck to the side against the pillow 30 and may be provided support for his head or neck by the pillow 30.

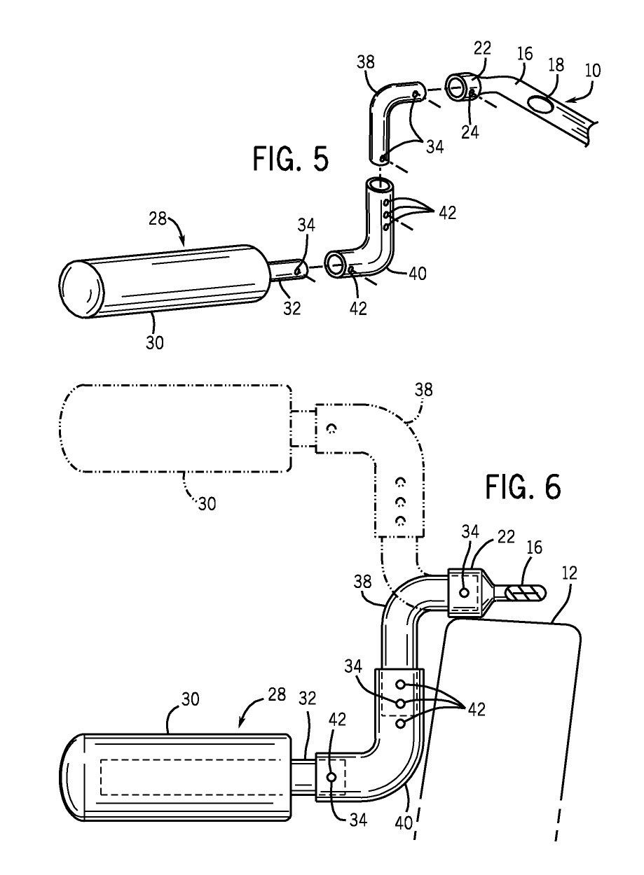

With reference to FIGS. 5 and 6, in alternative embodiments of the present invention, the car seat headrest 10 may be extended via a Z-shaped extender made up of an extension bar 40 and an extension connector 38. The extension connector 38 may be a bar or tube about ½-inch in diameter bent in an L-shape that is about 3 to 4 inches long on the long side and about 1.5 inches long on the short side. The extension connector 38 may have pop-up buttons 34 near both ends to connect to other components of the car seat headrest 10 having holes 42 and through-holes 24. The extension bar 40 may be an L-shaped bar or hollow pipe that may be about 1/16 to ⅛ inches thick, about 3 to 4 inches long on the long side and about 1.5 inches long on the short side. The extension bar 40 may also have approximately 3 to 6 holes 42 on the long side and a pair of holes 42 on the short side, and may be operable to accept and secure the extension connector 38 into one end and the insert bar 32 into the other end. The extension bar 40 may be adjustable to provide different lengths of extension to the insert bar 32.

In use, the extension connector 38 and the extension bar 40 may be used to extend the insert bar 32 as well as to provide additional flexibility in positioning the insert bar 32. The extension connector 38 may be inserted at one end into a locking collar 22 of the holding bar 16 and at the other end into the extension bar 40. The insert bar 32 may be inserted into the extension bar 40. As shown with the solid lines in FIG. 6, the extension connector 38 and the extension bar 40 may be connected to the holding bar 16 to form a downwards Z shape so that the insert bar 32 may be connected to the extension bar 40 at a lower height than the holding bar 16. As shown with the dotted lines in FIG. 6, the extension connector 38 and the extension bar 40 may also be connected to the holding bar 16 to form an upwards Z shape so that the insert bar 32 may be connected to the extension bar 40 at a higher height than the holding bar 16.

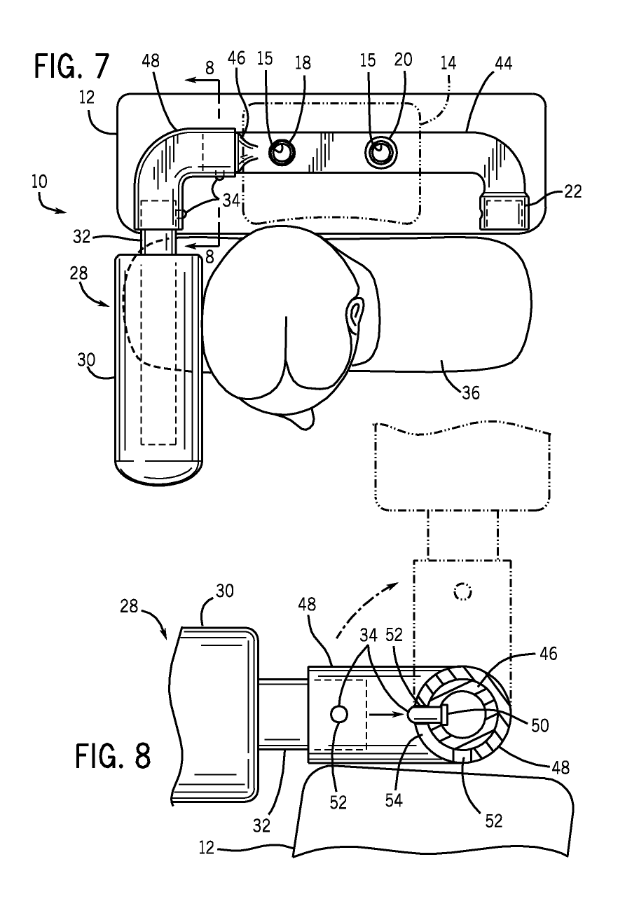

With reference to FIGS. 7 and 8, an L-shaped holding bar 44 may have a L-shaped connector 48 connected to a round end portion 46 of the L-shaped holding bar 44. The L-shaped connector 48 may serve as one of the legs 16a and 16b and the locking collar 22 in the embodiments show in FIGS. 1-4.

The L-shaped connector 48 may be connected to the L-shaped holding bar 44 via a through-hole 52 that may accept pop-up button 34 on the L-shaped holding bar 44 pushed through the through-hole 52. Further, the L-shaped connector 48 may be rotatable when connected to the L-shaped holding bar 44 via a circular rotation slot 54 that the pop-up button 34 may fit into to allow the L-shaped connector 48 to rotate. Thus, for example, the L-shaped connector 48 may be rotated so that it extends out horizontally from the L-shaped holding bar 44, or it may be rotated so that it extends out vertically from the L-shaped holding bar 44.

The L-shaped connector 48 may also be connected to a pillow portion 28 by being connected to an insert bar 32 via a through hole 52 that locks the insert bar 32 into the L-shaped connector 48 via a pop-up button 34 on the insert bar 32 that is fitted into the through hole 52.

It should be understood, of course, that the foregoing relates to exemplary embodiments of the invention and that modifications may be made without departing from the spirit and scope of the invention as set forth in the following claims.

We claim:

1. An apparatus comprising:
a holding bar attachable to a car seat; and
a head support portion attached to the holding bar, the head support portion extending above a seat base of the car seat when the holding bar is attached to the car seat.

2. The apparatus of claim 1, wherein the holding bar includes one or more holes, and wherein the holding bar is securable to the car seat via one or more headrest stays inserted through the one or more holes into one or more headrest stay holes.

3. The apparatus of claim 1, wherein the holding bar is a U-shaped bar.

4. The apparatus of claim 3, wherein the holding bar includes an opening at each end operable to accept and connect the head support portion to the holding bar.

5. The apparatus of claim 1, further comprising:
an extension portion having a first end attachable to the holding bar and a second end attachable to the head support portion.

6. The apparatus of claim 5, wherein the extension portion is a Z-shaped bar.

7. The apparatus of claim 1, wherein the head support portion includes an insert bar and a pillow attached to the insert bar.

8. An apparatus comprising:
a holding bar having a U shape and also having one or more openings operable to accept one or more headrest stays of a car seat;
an extension portion having a Z shape, the extension portion having a first end attached to a first end of the holding bar;
an insert bar attached to a second end of the extension portion, the insert bar extending above a seat base of the car seat when the holding bar is attached to the car seat; and
a pillow having a cylindrical shape that is wrapped around at least a portion of the head support portion.

9. The apparatus of claim 8, wherein the one or more openings comprise a fitted hole and an adjusting hole.

10. The apparatus of claim 8, wherein the extension portion is adjustable in length.
